(19) United States
(12) Patent Application Publication
(10) Pub. No.: US 2019/0318418 A1
(43) Pub. Date: Oct. 17, 2019

(54) SYSTEMS AND METHODS FOR AUTOMATED ADVANCE ORDER PAYMENT PROCESSING

(71) Applicant: Walmart Apollo, LLC, Bentonville, AR (US)

(72) Inventors: Karan Khurana, Foster City, CA (US); Chandrasekar Ramalingam, Belmont, CA (US); Vasu Palanisamy, San Ramon, CA (US); Varun K. Sahu, Union City, CA (US)

(21) Appl. No.: 16/373,411

(22) Filed: Apr. 2, 2019

Related U.S. Application Data
(60) Provisional application No. 62/657,506, filed on Apr. 13, 2018.

(51) Int. Cl. G06Q 30/06; G06Q 20/28; G06Q 20/40

(52) U.S. Cl. CPC G06Q 30/0637; G06Q 20/4037; G06Q 20/28

(57) ABSTRACT

Systems, apparatuses, and methods are provided herein for automated advance purchase payment processing. A central computer system being configured to select a set of customer orders with a scheduled purchase date that is n days from a current date to process payment. In the event that the authorization fails and an error code corresponds to a payment information error, the system automatically generates a notification message to the customer at the messaging server, submits the updated customer payment information to the bank system, and processes the advance product order on the scheduled purchase date for delivery.

### CROSS-REFERENCE TO RELATED APPLICATIONS

This application claims the benefit of U.S. Provisional Application No. 62/657,506, filed Apr. 13, 2018, which is incorporated herein by reference in its entirety.

### TECHNICAL FIELD

These teachings relate generally to electronic payment processing systems.

### BACKGROUND

A pre-order is a type of advance order that is sometimes offered for popular items such as books, video games, and electronics. Pre-orders allow customers to reserve their own personal copy of the product before the product is released. Typically, a customer places a preorder weeks or months ahead of time and is charged for the product on or near the release date.

### BRIEF DESCRIPTION OF THE DRAWINGS

Disclosed herein are embodiments of systems and methods for advance order payment processing. This description includes drawings, wherein:

FIG. 1 comprises a system diagram as configured in accordance with various embodiments of these teachings;

FIG. 2 comprises a system diagram as configured in accordance with various embodiments of these teachings;

FIG. 3 comprises a flow diagram as configured in accordance with various embodiments of these teachings; and

FIG. 4 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for processing payment for advance orders. In some embodiments, a system for advance product order payment processing comprises an advance product order database comprising a plurality of product orders, a customer account database comprising payment information for a plurality of customer accounts, a payment system coupled to one or more payment processor systems, a messaging server configured to generate and send messages to customers, and a central computer system coupled to the advance product order database, the customer account database, the payment system, and the messaging server. The central computer system is configured to select a set of customer orders in the advance product order database, the set of customer orders comprising customer orders with a scheduled purchase date that is n days from a current date, retrieve, from the customer account database, customer payment information associated with one or more of the set of customer orders, the customer payment information comprising information provided by a customer, submit the customer payment information associated with the set of customer orders to a payment processor system for authorization via the payment system on the current date, for each advance product order of the set of customer orders: in the event that the authorization fails and an error code received from the payment processor system corresponds to a payment information error: automatically generate a notification message to the customer at the messaging server, receive updated customer payment information in response to the notification message and before a cancelation date for the advance product order, submit the updated customer payment information to the payment processor system via the payment system, and process the advance product order on the scheduled purchase date for delivery.

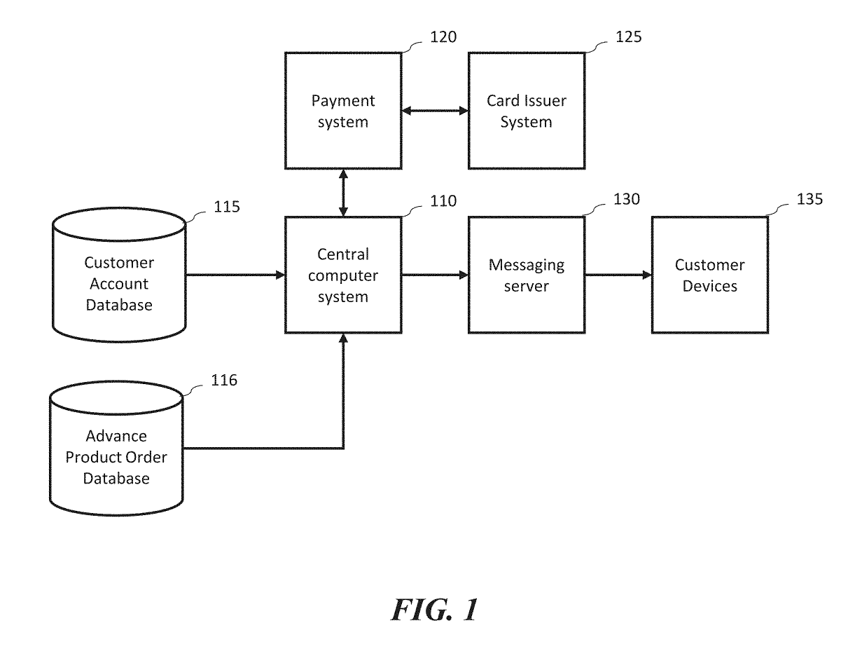

Referring next to FIG. 1, a block diagram of a system according to some embodiments is shown. The system comprises a central computer system 110, a customer account database 115, a payment system 120, bank systems 125, a messaging server 130, and customer devices 135.

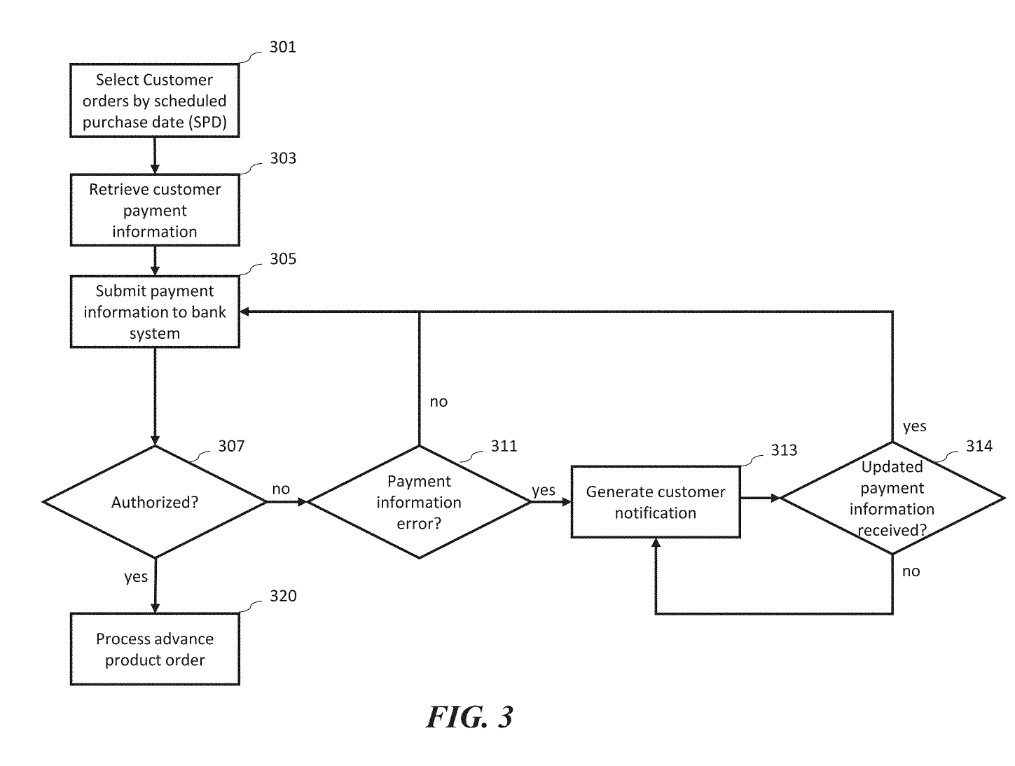

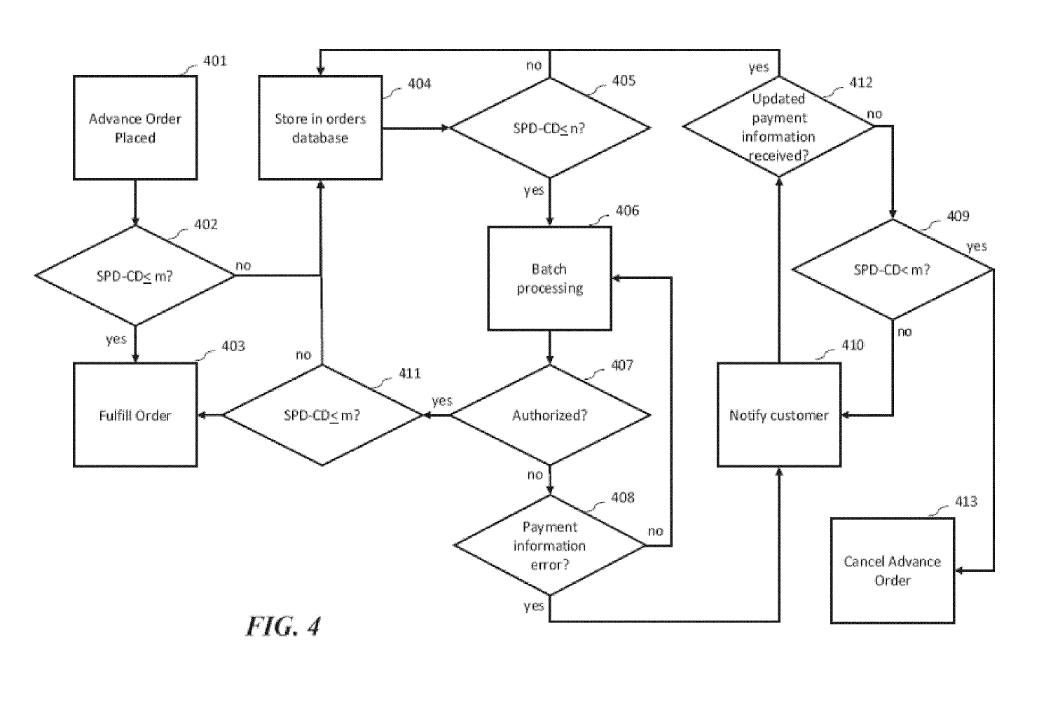

The central computer system 110 may comprise a processor-based system such as one or more of an enterprise computer system, a server system, a networked computer system, a cloud-based server, and the like. The central computer system 110 comprises a control circuit and a memory. The control circuit may comprise a processor, a central processor unit, a microprocessor, and the like. The memory may include one or more of a volatile and/or non-volatile computer-readable memory devices. In some embodiments, the memory stores computer-executable codes that cause the control circuit to process advance order payments and provide customer notifications when advance order payment fails to authorize. In some embodiments, the control circuit of the central computer system 110 may further be configured to receive payment information from customer devices 135, store the payment information in the customer account database 115, and process payments a set number of days before the scheduled purchase date of advance orders via the payment system 120. If the payment authorization fails, the central computer system 110 may determine whether the error is associated with the customer payment information or some other system issues. If the error is associated with customer payment information, the central computer system 110 may cause the messaging server 130 to generate a message to send to the customer device 135. In some embodiments, the computer-executable code stored in the memory may cause the control circuit of the central computer system 110 to perform one or more steps described with reference to FIGS. 3-4 herein.

The customer account database 115 is configured to store payment information for a plurality of customers. In some embodiments, the customer account database 115 may comprise one or more computer-readable mass memory storage devices. The customer account database generally stores customer profiles and payment information. In some embodiments, payment information may comprise one or more of customer name, address, account number, credit card number, debit card number, expiration date, security code, phone number, and passcode. Generally, payment information comprises information needed to request payment authorization from a bank system 125. In some embodiments, payment information may comprise information provided by a customer when an advance product order is placed and/or information stored as a saved method of payment in the customer profile. In some embodiments, the customer account database 115 may further store other customer account information such as other payment methods, customer contact information, customer payment history, etc.

The advance product order database 116 is configured to store advance orders placed by customers. An advance product order generally refers to an order that is placed before a scheduled purchase date on which the order is to be charged and processed for fulfillment. In some embodiments, advance product order comprises preorder and/or an order for a temporarily out of stock item. For a pre-orders, the scheduled purchase date may correspond to the release date of the product. For an out-of-stock item, the scheduled purchase date may correspond to the back-in-stock date of the item. In some embodiments, the customer may select a future fulfillment date to generate an advance product order even if the product is currently available. In some embodiments, records of advance orders may comprise one or more of selected item(s), scheduled purchase date, and selected payment method. In some embodiments, the customer account database 115 and the advance product order database 116 may be implemented as a single database that associates customer accounts and payment information with orders.

The payment system 120 generally refers to a merchant-end system configured to process payments for customer orders. In some embodiments, the payment system 120 may comprise an enterprise computer system, a server system, a networked computer system, a cloud-based server, and the like. The payment system 120 comprises a control circuit and a memory. The control circuit may comprise a processor, a central processor unit, a microprocessor, and the like. The memory may include one or more of a volatile and/or non-volatile computer-readable memory devices. In some embodiments, the memory stores computer-executable codes that cause the control circuit to interface with the bank systems 125 to obtain payment authorization. In some embodiments, the payment system 120 may submit payment information to the bank system 125 and determine a reason/error code based on the communication with the bank system 125. Examples of reason/error codes that may be determined by the payment system 120 are provided in Table 1 herein. In some embodiments, the payment system 120 may be configured to aggregate payment authorization requests and submit them in batches to one or more bank systems 125. In some embodiments, the payment system 120 and the bank systems 125 may communicate over a network such as one or more of a secured network, the Internet, a public network, a private network, and the like. The bank systems 125 may comprise authorizer and/or issuer systems of credit cards and debit cards and/or mobile wallet providers.

The messaging server 130 generally refers to a merchant-end system configured to generate and send messages and may comprise an enterprise computer system, a server system, a networked computer system, a cloud-based server, and the like. The messaging server 130 comprises a control circuit and a memory. The control circuit may comprise a processor, a central processor unit, a microprocessor, and the like. The memory may include one or more of a volatile and/or non-volatile computer-readable memory devices. In some embodiments, the memory stores computer-executable codes that cause the control circuit to generate notification messages for customer devices 135. In some embodiments, the messaging server 130 may receive a list of customers to notify from the central computer system 110 and the messaging server 130 may fill out message templates with customer's account information from the customer account database 115 and send the message to the customer based on the customer's contact information. In some embodiments, the notification message may comprise a link to a website and/or a phone number to a customer service center for the customer to provide the updated customer payment information. In some embodiments, notification messages may comprise an email, a text message, a voice message (e.g. “robocall), a mobile messaging application message (e.g. Google chat, Facebook messenger, etc.), and the like. In some embodiments, the messaging server 130 and the customer devices 135 may communicate over a network such as one or more of a secured network, the Internet, a public network, a private network, a cellular network, a mobile data network, and the like.

The customer devices 135 may comprise user interface devices with user input/output devices. In some embodiments, customer devices 135 may comprise one or more of a mobile phone, a smartphone, a personal computer, a tablet computer, a wearable device, a home assistant device, a voice controlled device, and the like. In some embodiments, a customer device 135 may provide an advance purchase user interface for the customers to select products to order, enter payment information, configure their accounts, and/or view messages from the messaging server 130. In some embodiments, the advance purchase user interface may comprise one or more of a mobile application, a website, a cloud-based user portal, a desktop application, and the like.

In some embodiments, one or more of the central computer system 110, the customer account database 115, the advance product order database 116, the payment system 120 and the messaging server 130 may comprise one or more individually implemented and/or shared hardware systems. In some embodiments, the payment system 120 and/or the messaging server 130 may be implemented as software module(s) on the central computer system 110 or implemented as separate physical systems. In some embodiments, one or more of the central computer system 110, the payment system 120 and the messaging server 130 may individually and/or collectively perform one or more steps described with reference to FIGS. 3-4 herein.

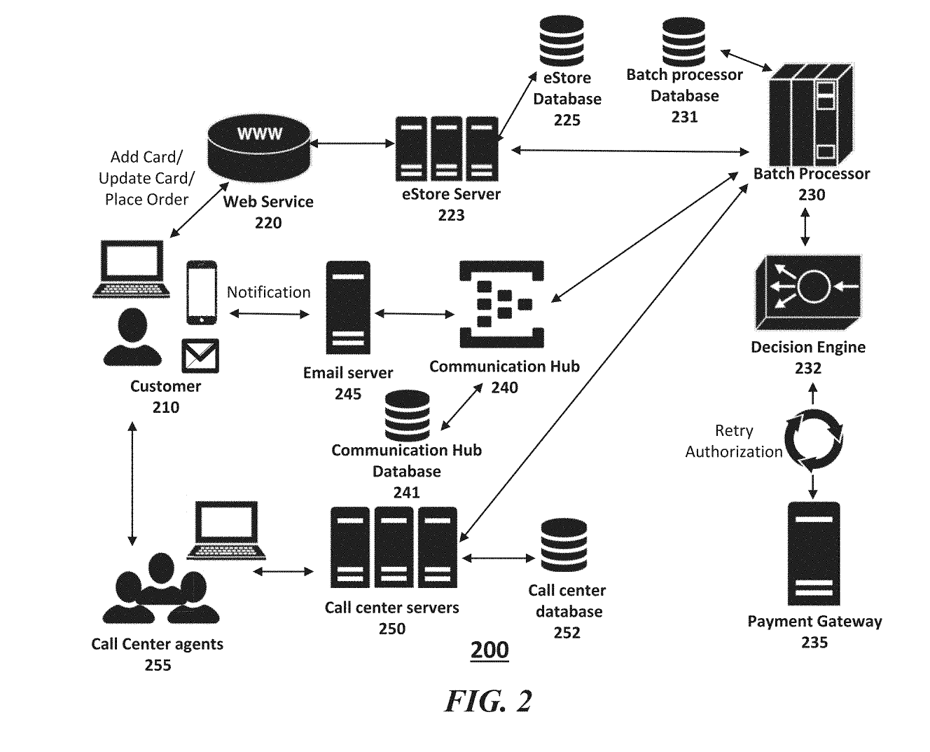

Referring next to FIG. 2, an illustration of a system according to some embodiments is shown. In the system 200, a customer 210 may use a web service 220 provided by an eStore server 223 to add card information, updated card information, and/or place conventional or advance orders for products or services. In some embodiments, the web service 220 may comprise a website, a mobile application, a desktop application, and the like configured to provide a graphical user interface (GUI) to customers of the eStore. In some embodiments, the eStore database 225 may store customer profiles, payment information, and orders received via the web service 220. In some embodiments, eStore database 225 may further store information associated with products and services offered through the eStore server and/or terms and conditions of advance orders. The eStore server 223 may use the information stored in the eStore database 225 to determine the information to display in the web service 220 user interface.

The batch processor 230 may generally be configured to batch payments for the eStore server 223. In some embodiments, the batch processor 230 may aggregate a set of payment requests (e.g. for each day, every 6 hours, etc.) to process. The batch payment requests are then forwarded to bank systems via the payment gateway 235. If a request is authorized, the batch processor 230 communicates the authorization to the eStore server 223 and the customer's account is updated. If a payment request fails, the decision engine 232 is configured to determine how to handle the rejected payment authorization request. In some embodiments, if the authorization failure is associated with a system error, the decision engine 232 may be configured to periodically attempt resubmission of the authorization request without notifying the customers 210 or the call centers. If the authorization failure is associated with payment information (e.g. card expired, billing address does not match, insufficient fund, etc.) the decision engine 232 may send the failed customer accounts and/or payment information to the communication hub 240 and/or the call center servers 250. In some embodiments, the results of authorization attempts may be stored in the batch processor database 231 and used by the batch processor 230 and/or the decision engine 232 to determine whether and when to resubmit customer payment information and/or send notifications to customers.

The communication hub 240 may be configured to generate notification messages for customers based on payment information errors reported by the batch processor 230. In some embodiments, the communication hub 240 may use the communication hub database 241 to generate the messages. The communication hub database 241 may store email templates and customer contact information. The generated messages are then sent to customers 210 via an email server and over a network. In some embodiments, a notification message may comprise a link to a website and/or a phone number to a customer service center for the customer to provide the updated customer payment information. When a customer 210 receives a notification message, a customer may access the web service 220 to provide updated payment information and/or contact a call center agent 255 for assistance.

In some embodiments, the batch processor 230 may further report payment information errors to call center servers 250. Customer order, account, and payment information may be stored in the call center database 252 to be accessed by call center agents 255 to assist customers with updating their payment information. For example, while on a call with a customer, a call center agent may access a user interface provided by the call center servers 250 to review customer accounts, advance orders, and payment information.

In some embodiments, one or more components of the system 200 shown in FIG. 2 may be communicatively coupled to each other via a data network such as one or more of a secured network, the Internet, a public network, a private network, and the like. In some embodiments, one or more of the web service 220, the eStore server 223, the batch processor 230, the decision engine 232, the payment gateway 235, the communication hub 240, the email server 245, and the call center servers 250 may comprise one or more individually implemented and/or shared hardware systems. In some embodiments, one or more of the web service 220, the eStore server 223, the batch processor 230, the decision engine 232, the payment gateway 235, the communication hub 240, the email server 245, and the call center servers 250 may be implemented as software module another system or be implemented as a physically separated system. In some embodiments, one or more of the web service 220, the eStore server 223, the batch processor 230, the decision engine 232, the payment gateway 235, the communication hub 240, the email server 245, and the call center servers 250 may individually and/or collectively perform one or more steps described with reference to FIGS. 3-4 herein.

In some embodiments, the eStore database 225, the batch processor database 231, the communication hub database 241, and the call center database 252 may comprise computer-readable mass storage devices. In some embodiments, one or more of the eStore database 225, the batch processor database 231, the communication hub database 241, and the call center database 252 may be implemented on one or more shared or individual physical devices. In some embodiments, one or more of the eStore database 225, the batch processor database 231, the communication hub database 241, and the call center database 252 may be implemented on one or more memory devices of another component of the system 200. In some embodiments, the eStore database 225, the batch processor database 231, the communication hub database 241, and the call center database 252 may comprise one or more server-based and/or cloud-based storage databases accessible by one or more of the other components of the system 200.

Referring next to FIG. 3, a method for processing payments for advance product orders according to some embodiments is shown. The steps in FIG. 3 may generally be performed by a processor-based device such as an enterprise computer system, a central computer system, a server, a cloud-based server, an order management system, a personal computer, a user device, etc. In some embodiments, the steps in FIG. 3 may be performed by one or more of the central computer system 110, the payment system 120, and the messaging server 130 described with reference to FIG. 1 and/or one or more of the eStore server 223, the batch processor 230, the decision engine 232, the payment gateway 235, the email server 245, the communication hub 240, and the call center server 250 described with reference to FIG. 2 herein.

In some embodiments, prior to step 301, a customer has placed an advance product order to be fulfilled on a scheduled purchase date (SPD). In setting up the advance order, the customer may configure a customer account comprising one or more of customer information, shipping information, payment information, etc. and select one or more products to purchase on the SPD.

In some embodiments, when an advance product order is initially placed, the system may submit an initial payment authorization request to validate the provided payment information and/or collect a deposit. The system then stores the payment information provided by the customer to be charged at a later time for the fulfillment of the order.

In step 301, the system selects a set of advance orders to process. In some embodiments, a set of customer orders are selected from an advance product order database 116 described with reference to FIG. 1 herein. In some embodiments, the set of customer orders comprise customer orders with a scheduled purchase date that is n days (e.g. 5 days, 1 week, 10 days, etc.) from a current date. In some embodiments, the selected set of customer orders comprises customer orders with a scheduled purchase date that is equal to or less than n days from the current date and more than m days (e.g. 0 day, 1 day, 2 days, etc.) from the current date. In some embodiments, on date i, the system may select customer orders with SPDs that is between i+m and i+n. For example, the system may select customer orders with SPDs that are between 2 to 10 days from the current date. The time period between SPD-n and SPD-m may be referred to as the payment verification period during which the system attempts authorization with the payment information provided by the customer when the order is placed such that the order can be processed on SPD. In some embodiments, the system may only select customer orders with payment information that hasn't been verified during the payment verification period in step 301. In some embodiments, the system may run multiple verifications on customer's payment information during the payment verification period of an advance product order. In some embodiments, the values of n and m may be configurable variables. In some embodiments, the values of n and m may vary depending on the type of advance order and/or the type of items in the advance order. While time periods are generally described in terms of days in the present description, time periods used to select customer orders in step 301 may be based on hours, minutes, weeks, etc. For example, m may correspond to 36 hours prior to the scheduled purchase time (e.g. June 3^{rd} at 3 pm).

In step 303, the system retrieves customer payment information for the orders selected in step 301. In some embodiments, the system retrieves customer payment information for the customer account from the customer account database. In some embodiments, the customer payment information comprises information provided by a customer when the advance product order is placed and/or comprises saved payment method associated with the customer profile. In some embodiments, customer payment information comprises one or more of customer name, address, account number, credit card number, debit card number, expiration date, security code, mobile wallet account, phone number, and passcode. In some embodiments, payment information may be retrieved from the customer account database 115, the advance product order database 116 described with reference to FIG. 1 and/or the eStore database 225 described with reference to FIG. 2.

In step 305, the system submits the customer payment information to one or more bank systems. In some embodiments, customer payment information may be submitted via a payment system configured to aggregate and batch process charge requests. In some embodiments, the system may further select from a plurality of payment processors based on the payment information (e.g. Visa, Master, or bank account). In some embodiments, the payment system(s) may comprise one or more of the payment system 120 described with reference to

FIG. 1, the batch processor 230, the decision engine 232, and the payment gateway 235 described with reference to FIG. 2, or other similar devices.

In step 307, the system determines whether the payment has been authorized. In some embodiments, a payment system may provide either an authorization confirmation and/or an error code based on the bank system's response or lack of response to the charge request. If an authorization confirmation is received, the system proceeds to step 320 to fulfill the advance product order on the scheduled purchase date for pickup or delivery.

In step 311, the system uses the received error code to determine whether the error is associated with a customer payment information error. In some embodiments, the payment system is configured to generate a reason/error code for each payment authorization request based on the payment system's communication with a bank system. The table below provides several examples of codes that may be generated by the payment system. The table below is provided as an example only, codes used by systems may vary without departing from the spirit of the present disclosure.

TABLE 1
Exemplary Error Codes

| Rea- | | | Block |
|---|---|---|---|
| son | | | Check- |
| Code | Text | Reason | out? |
| 0 | Autho- | The transaction is authorized | No |
| | rized | | |
| 10 | Declined | The transaction is declined | Yes |
| | | May be because of insufficient funds, | |
| | | expired card, flat decline etc. | |
| 12 | Referral | Refer the card issuer (Call the card issuer) | Yes |
| 14 | Pickup | Possible fraud or unauthorized use | Yes |
| 16 | AVS | Address verification failed | Yes |
| | Check | | |
| | failed | | |
| 18 | CVV | The CVV was incorrect | Yes |
| | Failed | | |
| 19 | XREF | The Xref service (Card reference −> | No |
| | Service | Encrypted card number) service is not | |
| | Error | working | |
| 20 | Authorizer | The authorizer returned with an Error RC | No |
| | Error | | |
| 91 | Network | The transaction timed out between the | No |
| | Timeout | authorizer and bank/issuer (Platform) | |
| 99 | Epay | 99.F2 - Timeouts - No response from | No |
| | Dismissal | authorizer | |
| | No | 99.F3 - Epay at Max capacity | |
| | No | 99.F4 - Transaction in progress - Either the | |
| | | reversal is sent when authorization is | |
| | | happening or a second authorization is sent | |
| | | too quick | |
| | No | 99.F5 - Reversal error - Reversal sent to | |
| | | different platform | |
| | No | 99.F6 - Auth links down-All links to | |
| | | authorizer from App is down | |
| | No | 99.F7 - Card type error - BIN Not found | |
| | No | 99.F8 - Epay not accepting work | |
| | No | 99.FA - Cannot reverse due to original not | |
| | | found - The original transaction didn't | |
| | | happen in this Epay | |
| | No | 99.FB - Encryption/Decryption error - The | |
| | | encrypted card number couldn't be decrypted | |

For example, if the payment gateway is not able to contact the bank system, the gateway may generate an error code associated with network issues (e.g. #91). If the error code is not associated with a payment information error, the system returns to 305 and attempts to resubmit the payment information for authorization. In some embodiments, the system may insert a wait time (e.g. 5 minutes, 1 hour, 1 day) between each resubmission attempt. In some embodiments, these failed requests may be added to the next set of customer orders for batch payment processing.

If the error code is associated with customer payment information error (e.g. #16, #18), the process proceeds to step 313. In step 313, the system automatically generates a notification message for the customer at a messaging server. In some embodiments, the messaging server may generate a message using a message template and the customer's information from the customer account database. In some embodiments, the notification message comprises a link to a web site and/or a phone number to a customer service center for the customer to provide the updated customer payment information. In some embodiments, notification messages may comprise an email, a text message, a voice message (e.g. “robocall), a mobile messaging application message (e.g. Google chat, Facebook messenger, etc.), and the like. In some embodiments, the notification message may be generated and sent to customers with one or more of the messaging server 130 described with reference to FIG. 1, the communication hub 240 and the email server 245 described with reference to FIG. 2, or other similar devices.

In step 314, the system determines whether the customer has provided updated payment information. In response to receiving the notification message in step 313, a customer may provide updated payment information via a website and/or by contacting a customer service agent. In some embodiments, the updated payment information may comprise a new form of payment (e.g. new credit card, different bank account, etc.). In some embodiments, the updated payment information may comprise modifications to the original payment information (e.g. new expiration date, new address, etc.). In some embodiments, when updated payment information is received, the system may immediately return to step 305 and try to obtain payment authorization with the updated payment information. In some embodiments, the updated payment information may be added to the next batch payment processing submission. In some embodiments, if the authorization also fails with the updated customer payment information, the system is further configured to automatically generate a second notification message to the customer at the messaging server by repeating steps 311 and 313 prior to PSD.

If no updated payment information is received in step 314, after a set period of time (e.g. 1 day, 48 hours, etc.) the process may return to step 313 and another notification message may be generated. In some embodiments, the system may periodically send notification messages to the customer until a payment is authorized and/or for a set period time. For example, the system may ask the customer to update payment information until m days before the SPD and may send a notification each day during the payment verification period. In some embodiments, the order may be fulfilled on SPD if updated payment information is received and authorized anytime before SPD. In some embodiments, discounts or promotions (e.g. bonus gift) included in the original advance product order may be maintained if payment is authorized by the SPD period even if payment authorization fails one or more times during the payment verification period.

In step 320, the advance product order is processed. In some embodiments, advance product orders are processed on the scheduled purchase date for fulfillment and/or delivery. In some embodiments, orders with verified payment information may be charged during the verification period and the order may be fulfilled on SPD. In some embodiments, orders with verified payment information may be charged on SPD when the order is ready to be fulfilled. In some embodiments, when payment information is verified in step 307, the system may update the customer account database to indicate the latest verification date of the payment method instead of proceeding directly to step 320. In some embodiments, the process may only proceed to step 320 on SPD.

In some embodiments, steps shown in FIG. 3 may be repeated periodically (e.g. daily, every 12 hours, etc.) for orders in the customer order database and the selected orders may be grouped for batch processing. In some embodiments, steps shown in FIG. 3 may be repeated multiple times for an advance product order during the verification period. For example, starting from 10 days before SPD, the system may check the payment information repeatedly up onto a day before SPD to ensure that the payment information is valid on SPD.

In some embodiments, payment requests may be processed, resubmitted, and/or sent to the messaging server in a batch. For example, the system may aggregate all orders to be verified for the day and submit them at night to a bank system. Requests rejected for system errors may be aggregated and resubmitted in another batch at a later time (e.g. 1 hour later, 3 hours later, etc.). In some embodiments, in the event that the authorization fails and the error code corresponds to a system error, the central computer system is further configured to automatically resubmit the customer payment information to the payment processor system prior to the cancelation date. Requests rejected for payment information errors may be aggregated at the messaging server and notifications may be generated and sent out to customers together at a set time (e.g. 8 am, noon, etc.).

Referring next to FIG. 4, a process for processing payments for advance product orders according to some embodiments is shown. The steps in FIG. 4 may generally be performed by a processor-based device such as an enterprise computer system, a central computer system, a server, a cloud-based server, an order management system, a personal computer, a user device, etc. In some embodiments, the steps in FIG. 4 may be performed by one or more of the central computer system 110, the payment system 120, and the messaging server 130 described with reference to FIG. 1 and/or one or more of the eStore server 223, the batch processor 230, the decision engine 232, the payment gateway 235, the email server 245, the communication hub 240, and the call center server 250 described with reference to FIG. 2 herein.

In step 401, an advance order is placed. A customer may select item(s) and enter or select a payment method to place an order to be shipped at a later date. In some embodiments, the ship date may be selected by the customer. In some embodiments, the ship date may correspond to the date that the product becomes available. In some embodiments, the system may verify the payment method in step 401 by submitting a verification/authorization request to a payment network and only create an order when a verified payment method is provided. In step 402, the system determines whether the differences between the scheduled purchase date (SPD) and the current date (CD) is equal to or less than m days. SPD is generally assumed to be after the current date in FIG. 4. If the current date is equal or less than m days from the SPD, the process proceeds to step 403 and the order is processed for fulfillment.

If the SPD is more than m days away, in step 404, the order is stored in a database of advance orders for later fulfillment. In step 405, the system periodically checks for orders with an SPD that is less than n days away. In step 406, orders with an SPD that is less than n days away are aggregated and submitted for batch processing. In step 407, the system determines whether the payment information for each order is authorized. In some embodiments, step 407 may comprise a verification of an order's payment information without charging the customer. In some embodiments, in step 411, the system may determine whether the SPD for the order is less than m days away. If the SPD is still more than m days away, the order may be kept in the orders database to be verified/authorized at a later date during the verification period. In step 411, if SPD is equal to or less than m days, the order is processed for fulfillment. In some embodiments, if authorization is successful, the process may proceed directly to step 403 and step 411 may be omitted.

If, in step 407, authorization fails, the system determines whether the error is associated with payment information error in step 408. If the error is not a payment information error, the order is added to the next group of orders for batch processing in step 406. If the authorization failure is associated with payment information error, in step 410, the system notifies the customer. If updated payment information is received in step 412 in response to the notification, the payment information in the order database is updated. In some embodiments, the system may verify the updated payment information received in step 412 prior to updating the database. If updated information is not received within a set period of time, in step 409, the system determines whether the SPD of the order is less than m days away. If an order's SPD is less than m days away, in step 413, the advance order is canceled. If the order's SPD is more than m days away, the system may again notify the customer to provide updated payment information in step 410.

In some embodiments, the steps shown in FIG. 4 may be repeated periodically (e.g. daily, every 12 hours, etc.) for a plurality of orders in the customer order database. In some embodiments, steps shown in FIG. 3 may be repeated multiple times for an advance product order during the verification period. For example, starting from 10 days before SPD, the system may check the payment information repeatedly up onto a day before SPD to ensure that the payment information is valid on SPD.

With the systems and methods described herein, when a payment method becomes invalid after a customer places an advance order, the customer could be given one or more opportunities to address payment information errors so that the order can still be fulfilled on the scheduled date without interruption.

In some embodiments, a system for advance product order payment processing comprises an advance product order database comprising a plurality of product orders, a customer account database comprising payment information for a plurality of customer accounts, a payment system coupled to one or more payment processor systems, a messaging server configured to generate and send messages to customers, and a central computer system coupled to the advance product order database, the customer account database, the payment system, and the messaging server. The central computer system is configured to select a set of customer orders in the advance product order database, the set of customer orders comprising customer orders with a scheduled purchase date that is n days from a current date, retrieve, from the customer account database, customer payment information associated with one or more of the set of customer orders, the customer payment information comprising information provided by a customer, submit the customer payment information associated with the set of customer orders to a payment processor system for authorization via the payment system on the current date, for each advance product order of the set of customer orders: in the event that the authorization fails and an error code received from the payment processor system corresponds to a payment information error: automatically generate a notification message to the customer at the messaging server, receive updated customer payment information in response to the notification message and before a cancelation date for the advance product order, submit the updated customer payment information to the payment processor system via the payment system, and process the advance product order on the scheduled purchase date for delivery.

In one embodiment, a method for advance product order payment processing comprises selecting, with a control circuit, a set of customer orders in an advance product order database comprising a plurality of product orders, the set of customer orders comprising customer orders with a scheduled purchase date that is n days from a current date, retrieving, from a customer account database, customer payment information associated with one or more of the set of customer orders, the customer payment information comprising information provided by a customer, submitting the customer payment information associated with the set of customer orders to a payment processor system for authorization via a payment system on the current date, for each advance product order of the set of customer orders: in the event that the authorization fails and an error code received from the payment processor system corresponds to a payment information error: automatically generating a notification message to the customer at a messaging server, receiving, at the control circuit, updated customer payment information in response to the notification message and before a cancelation date for the advance product order, submitting, with the control circuit, the updated customer payment information to the payment processor system via the payment system, and processing the advance product order on the scheduled purchase date for delivery.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A system for advance product order payment processing comprising:
an advance product order database comprising a plurality of product orders;
a customer account database comprising payment information for a plurality of customer accounts;
a payment system coupled to one or more payment processor systems;
a messaging server configured to generate and send messages to customers; and
a central computer system coupled to the advance product order database, the customer account database, the payment system, and the messaging server, the central computer system being configured to:
select a set of customer orders in the advance product order database, the set of customer orders comprising customer orders with a scheduled purchase date that is n days from a current date;
retrieve, from the customer account database, customer payment information associated with one or more of the set of customer orders, the customer payment information comprising information provided by a customer;
submit the customer payment information associated with the set of customer orders to a payment processor system for authorization via the payment system on the current date;
for each advance product order of the set of customer orders:
in the event that the authorization fails and an error code received from the payment processor system corresponds to a payment information error:
automatically generate a notification message to the customer at the messaging server;
receive updated customer payment information in response to the notification message and before a cancelation date for the advance product order;
submit the updated customer payment information to the payment processor system via the payment system; and
process the advance product order on the scheduled purchase date for delivery.

2. The system of claim 1, wherein in the event that the authorization fails and the error code corresponds to a system error, the central computer system is further configured to:
automatically resubmit the customer payment information to the payment processor system prior to the cancelation date.

3. The system of claim 1, wherein in the event that the authorization is successful, the central computer system is further configured to: fulfill the advance product order on the scheduled purchase date for delivery.

4. The system of claim 1, wherein the advance product order comprises preorder and/or an order for a temporarily out of stock item.

5. The system of claim 1, wherein the central computer system is further configured to:
periodically send the notification message to the customer until updated payment information is received or up until the cancelation date.

6. The system of claim 1, wherein in the event that the authorization also fails with the updated customer payment information, the central computer system is further configured to:
automatically generate a second notification message to the customer at the messaging server.

7. The system of claim 1, wherein the notification message comprises a link to a website and/or a phone number to a customer service center for the customer to provide the updated customer payment information.

8. The system of claim 1, wherein submitting the customer payment information associated with the set of customer orders to the payment processor system for the authorization comprises batch payment processing.

9. The system of claim 8, wherein the updated customer payment information is added to a next set of customer orders for batch payment processing.

10. The system of claim 1, wherein the customer payment information comprises one or more of customer name, address, account number, credit card number, debit card number, expiration date, security code, phone number, and passcode.

11. A method for advance product order payment processing comprising:
selecting, with a control circuit, a set of customer orders in an advance product order database comprising a plurality of product orders, the set of customer orders comprising customer orders with a scheduled purchase date that is n days from a current date;
retrieving, from a customer account database, customer payment information associated with one or more of the set of customer orders, the customer payment information comprising information provided by a customer;
submitting the customer payment information associated with the set of customer orders to a payment processor system for authorization via a payment system on the current date;
for each advance product order of the set of customer orders:
in the event that the authorization fails and an error code received from the payment processor system corresponds to a payment information error:
automatically generating a notification message to the customer at a messaging server;
receiving, at the control circuit, updated customer payment information in response to the notification message and before a cancelation date for the advance product order;
submitting, with the control circuit, the updated customer payment information to the payment processor system via the payment system; and
processing the advance product order on the scheduled purchase date for delivery.

12. The method of claim 11, wherein in the event that the authorization fails and the error code corresponds to a system error:
automatically resubmitting the customer payment information to the payment processor system prior to the cancelation date.

13. The method of claim 11, wherein in the event that the authorization is successful, further comprising: fulfilling the advance product order on the scheduled purchase date for delivery.

14. The method of claim 11, wherein the advance product order comprises preorder and/or an order for a temporarily out of stock item.

15. The method of claim 11, further comprising:
periodically sending the notification message to the customer until updated payment information is received or up until the cancelation date.

16. The method of claim 11, wherein in the event that the authorization also fails with the updated customer payment information:
automatically generating a second notification message to the customer at the messaging server.

17. The method of claim 11, wherein the notification message comprises a link to a website and/or a phone number to a customer service center for the customer to provide the updated customer payment information.

18. The method of claim 11, wherein submitting the customer payment information associated with the set of customer orders to the payment processor system for the authorization comprises batch payment processing.

19. The method of claim 18, wherein the updated customer payment information is added to a next batch payment processing submission.

20. The method of claim 11, wherein the customer payment information comprises one or more of customer name, address, account number, credit card number, debit card number, expiration date, security code, phone number, and passcode.
